(19) United States
(12) Patent Application Publication
(10) Pub. No.: US 2008/0094676 A1
(43) Pub. Date: Apr. 24, 2008

(54) METHOD AND APPARATUS FOR MONITORING LASER POWER IN RASTER SCAN APPLICATIONS WITH MINIMAL IMAGE DISTORTION

(75) Inventors: Lawrence E. Lach, Chicago, IL (US); George T. Valliath, Winnetka, IL (US)

Correspondence Address: Mr. Ronald E. Prass, Jr.;Irving, Prass & Stelacone, LLP, Suite 205, 1419 Forest Drive, Annapolis, MD, 21403, US

(73) Assignee: Motorola, Inc., Schaumburg, IL (US)

(21) Appl. No.: 11/539,414

(22) Filed: Oct. 6, 2006

(51) Int. Cl. G02B 26/08

(52) U.S. Cl. 359/196

(57) ABSTRACT

An apparatus, method and electronic device for monitoring laser power during a raster scan projection operation using a single photodiode are disclosed. The method may include determining the position of a raster scan device during projection of an image, wherein if the raster scan position is in or near a blanking period, bright light is blocked from being projected and one of a red laser, a green laser, and a blue laser is tested.

### BACKGROUND OF THE INVENTION

1. Field of the Invention

The present invention relates to image projection systems, and in particular, to a method and apparatus for monitoring laser power in raster scan laser projection systems.

2. Introduction

An ultra-compact projection display, called a micro-projector, can provide an image larger than the hosting projecting device dimension. Such displays have the potential to overcome the display size limitation on mobile devices and can be used to display documents and images, for example. The displays can also help to overcome the input interface size limitation on mobile devices by displaying virtual input devices, such as keyboards.

One technology used for micro-projection is laser scanning, in which red, green and blue laser beams are scanned across a surface to form a full color image. Conventional laser scanners use separate photodiodes to monitor each of the red, green and blue lasers. These photodiodes monitor the laser power of each laser periodically to sense a decrease in laser power with time due to age, optical power drift, etc.

Thus, conventional lasers scanners energize red laser, the green laser and the blue laser one at a time, to test and monitor the lasers based on signals received from the three separate photodiodes. However, each time one of the lasers is energized, the majority of the generated light is projected as a bright spot onto the image screen. These bright spots caused by this monitoring process are distracting to someone viewing the image and may cause other distortions that distract from the image.

### SUMMARY OF THE INVENTION

An apparatus, method, and electronic device for monitoring laser power during a raster scan projection operation using a single photodiode are disclosed. The method may include determining the position of a raster scan device during projection of an image, wherein if the raster scan position is in a blanking period, bright light is blocked from being projected, and one of a red laser, a green laser, and a blue laser is tested.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a image projection system in accordance with a possible embodiment of the invention;

FIG. 2 illustrates an exemplary block diagram of a controller for implementing the raster scan laser scan monitoring process in accordance with a possible embodiment of the invention;

FIG. 3 illustrates an exemplary flowchart illustrating one possible raster scan laser power monitoring process in accordance with one possible embodiment of the invention;

FIG. 4 illustrates an exemplary diagram showing the raster scan laser power monitoring process during image blanking periods in accordance with one possible embodiment of the invention;

FIG. 5 illustrates an exemplary diagram showing the raster scan laser power monitoring process during image blanking periods using mechanical stops in accordance with one possible embodiment of the invention;

FIG. 6 illustrates an exemplary diagram showing the raster scan laser power monitoring process during image blanking periods using a color pattern technique in accordance with one possible embodiment of the invention; and

FIG. 7 illustrates an exemplary diagram showing a possible pixel averaging process used in the color pattern technique used in the raster scan laser power monitoring process during image blanking periods in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as an apparatus, method, and electronic device, and other embodiments that relate to the basic concepts of the invention.

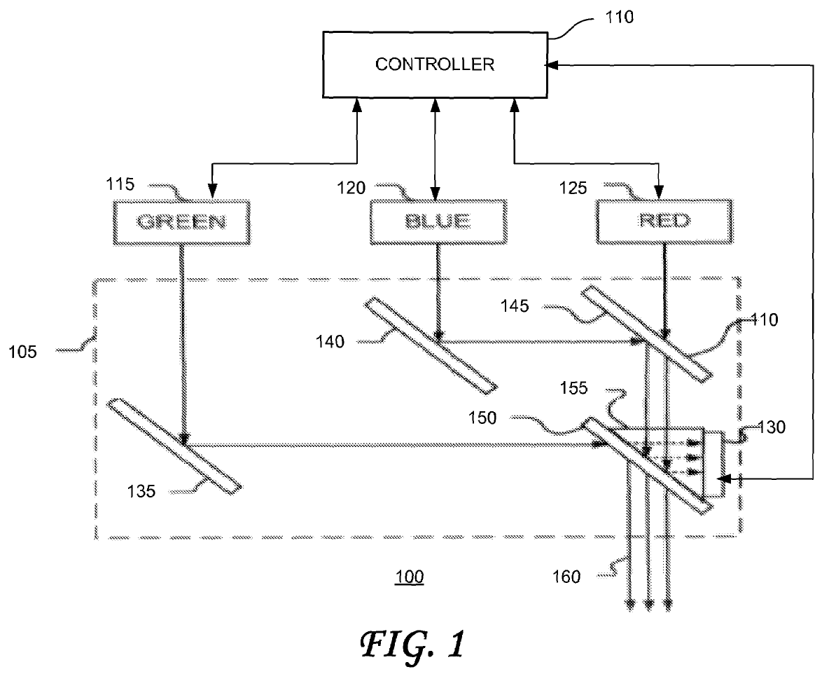

FIG. 1 illustrates an exemplary diagram of an image projection system 100 in accordance with a possible embodiment of the invention. In particular, the image projection system 100 may include includes beam combiner 105, controller 110, three light sources, namely a green laser 115, a blue laser 120, and a red laser 125, dichroic mirrors 135, 140, 145 and 150, prism structure 155 and photodiode 130.

The green laser 115, blue laser 120, and red laser 125 each produces light at its respective primary color wavelength and emits light uni-directionally in a separate beam. The beams are combined in the beam combiner 105 into a collimated and co-linear beam 160 using dichroic mirrors 135, 140, 145 and 150. Dichroic mirrors 135 and 150 reflect substantially all light from the green laser 115, while dichroic mirrors 140 and 145 reflect substantially all light from the blue laser 120. Mirrors 145 and 150 transmit substantially all light from the red laser 125.

A photodiode 130 is a sensor that converts optical power of a light source into an electrical signal. The electrical signal is typically proportional to the total light intensity that falls on the surface of the photodiode 130, and this light intensity is proportional to the optical power of the corresponding light source. The electrical signal is then sent to the controller 110 for feedback processing.

Conventionally when photodiodes are used to monitor the optical powers of laser diodes, one photodiode is used per laser diode. The signal from the photodiode is thus proportional to the total optical power of the laser diode. While this practice simplifies subsequent signal processing of the electrical signal, the use of a separate photodiode per laser diode requires three separate photodiodes to monitor the optical powers of three laser diodes in a red-green-blue (RGB) laser light source that is used for laser raster-scan projection. The use of three photodiodes adds both complexity and cost to the fabrication of an RGB light source.

In contrast, the image projection system 100 that uses a single photodiode 130 to monitor the optical powers from three laser diodes reduces both complexity and cost of the assembly of an RGB light source. However, the use of a single photodiode 130 creates a problem of how to use a single photodiode to perform separate R, G, and B power measurements during a raster scan process, while simultaneously introducing minimal image distortion to projected images.

As shown in FIG. 1, the photodiode 130 is positioned behind dichroic mirror 150 and is oriented to detect transmitted green light and reflected red and blue light. The intensity of the detected light is in direct proportion to the intensity of the primary light, so the output from the photodiode 130 provides a signal back to the controller 110 for use in feedback to control the light source intensity. More generally, dichroic mirrors 135, 140, 145 and 150 are used to direct the light from a light source, either by transmitting or reflecting substantially all of the light at a certain narrow band.

When the majority of light is transmitted through a dichroic mirror, the photodiode 130 can be placed on the same side of the mirror as the light source so as to collect the small amount not transmitted and not to interfere with the main beam. When the majority of light is reflected by a dichroic mirror, the photodiode 130 can be placed on the opposite side of the mirror from the light source so as to collect the small amount not reflected and not to interfere with the main beam. In both cases, the photodiode 130 is placed to receive light that is not directed along the main beam. That is, if the main beam emanates from one side of the mirror, the photodiode 130 is placed on the other side. It will be apparent to those of ordinary skill in the art that this approach can be used for other light directing means, such as prisms.

Optionally, a prism structure 155 may be used to provide a mechanical support for the photodiode 130 and dichroic mirror 150. That is, dichroic mirror 150 is mounted on one facet of prism structure 155, while photodiode 130 is mounted on another facet of the prism structure 155.

In a further embodiment, the dichroic mirror may be formed as a coating on the surface of the prism structure 155. The photodiode 130 may receive light from all of the light sources.

As described above, a timing scheme may be used to allow independent monitoring of each of the light sources 115, 120, 125. In certain time intervals, only one light source is activated. Since it is known which light source is activated, the photodiode 130 signal may be used as feedback for the controller 110 to adjust the corresponding light source 115, 120, or 125.

For applications where full color is not required, the image projection system 100 may use only two light sources. In FIG. 1, for example, any one of the light sources 115, 120, 125 could be omitted. However, omitting light source 120 eliminates two dichroic mirrors 140, 145. For full color applications, three or more light sources 115, 120, 125 may be used. The geometric arrangement shown in FIG. 1 makes efficient use of space, since the photodiode 130 is positioned in the space behind the dichroic mirror 150. This space would otherwise be unused.

The use of a single photodiode 130 in combination with the timing scheme described above reduces the volume further. The geometric arrangement results in improved efficiency compared to a system using back facet reflectivity (98% for mirrors versus 90% for back reflectivity). For example, for a red laser 125 used with back monitoring, a typical back reflectivity at about 90% is used. If back monitoring is not needed, the back reflectivity can be 95% or higher which makes the laser more efficient by decreasing the threshold current and increasing the slope efficiency.

This

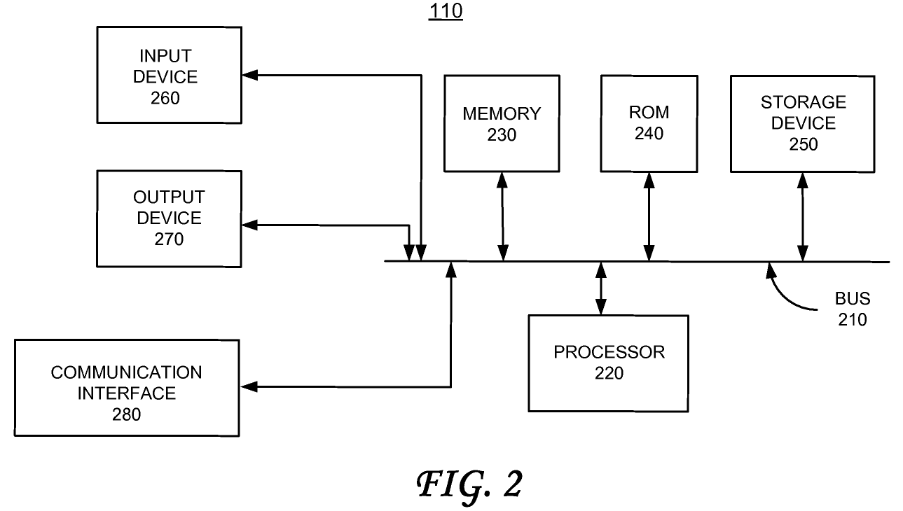

FIG. 2 shows a more detailed exemplary block diagram of the controller 110 which may implement one or more modules or functions of the laser power monitoring process. The controller 110 may include a bus 210, a processor 220, a memory 230, a read only memory (ROM) 240, a storage device 250, an input device 260, an output device 270, and a communication interface 280. Bus 210 may permit communication among the components of the controller 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, magnetic or optical recording media and its corresponding drive.

Input device 260 may include one or more conventional mechanisms that permit a user to input information to the controller 110, such as a keyboard, a mouse, a pen, a voice recognition device, buttons, etc. Output device 270 may include one or more conventional mechanisms that output information to the user, including a projection display, a printer, one or more speakers, or a medium, such as a memory, or a magnetic or optical disk and a corresponding disk drive.

Communication interface 280 may include any transceiver-like mechanism that enables the controller 110 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the image projection system 100, communication interface 280 may not be included in the exemplary controller 110 when the laser power monitoring process is implemented completely within a controller 110.

The controller 110 may perform such functions in response to processor 220 by executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

The image projection system 100 and the controller 110 illustrated in FIG. 1 and the related discussion are intended to provide a brief, general description of a suitable environment in which the invention may be implemented. Although not required, the invention will be described, at least in part, in the general context of computer-executable instructions, such as program modules, being executed by the controller 110. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

For illustrative purposes, the laser power monitoring process will be described below in relation to the block diagrams shown in FIGS. 1 and 2.

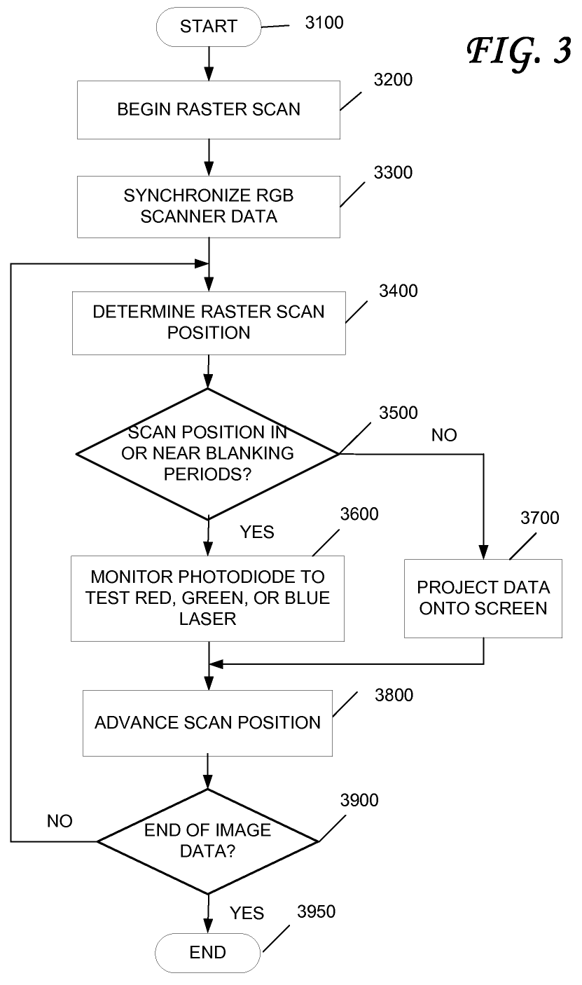

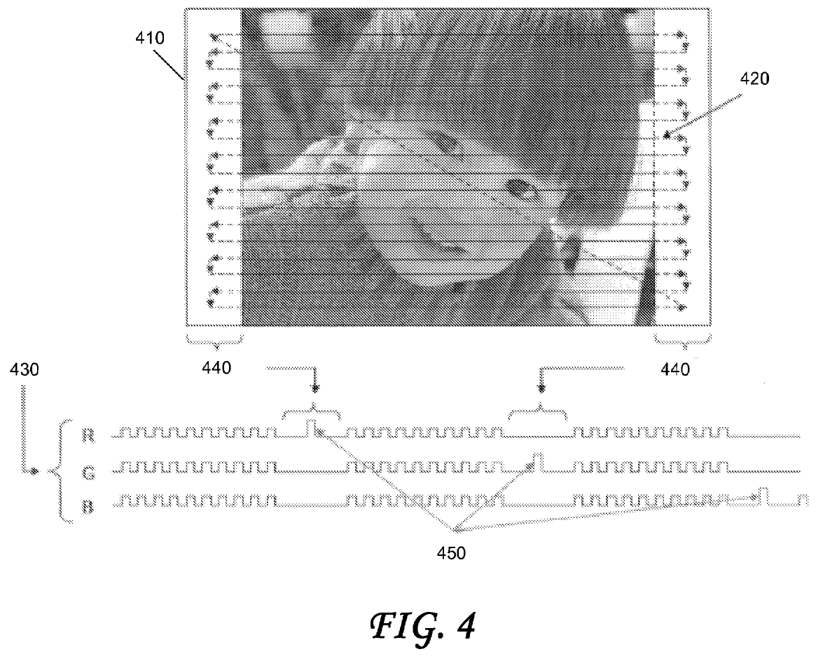

FIG. 3 is an exemplary flowchart illustrating some of the basic steps associated with a raster image projection process in accordance with a possible embodiment of the invention. The process begins at step 3100 and continues to step 3200 where the raster scan process begins. As shown in FIG. 4, raster scanning 420 in the context of the discussion herein is the process of projecting a video image 410 line by line left to right starting at the top-left corner. At the end of the line, the beam reaches the boundary area known as the “blanking period” 440 where the image does not exist but the raster scan 420 must have an area to move down one line and move back to the left.

Returning to FIG. 3, in step 3300, the controller 110 synchronizes the red, green and blue signals it receives. This synchronization process is inherently necessary due to a tight coupling between the release of the information in the datastream to the lasers and position of the raster scanner so that the correct information is projected in the correct place on the screen.

In step 3400, the controller 110 determines the raster scan position. This position can be determined by using the same electronic signals being sent to drive the raster scanner, for example. In step 3500, the controller 110 determines from the raster scanner position whether it is in the blanking period, as discussed above. If the controller 110 determines that the raster scanner is not in the blanking period, the process continues onto step 3700 where the image data are projected onto the screen. The process continues to step 3800 where the controller 110 advance the raster scanner's position. At step 3900, the controller 110 determines whether the scanner has reached the end of the image data. If not, the process returns to step 3400. If so, the process goes to step 3950 and ends (or ends for that image whereby the process may continue for the next image).

If however, the controller 110 determines that the raster scanner is in the blanking period, at step 3600, the photodiode 130 is monitored and one of the lasers is tested. As shown in FIG. 4, the laser signals 430 for red (R), green (G), and blue (B) operate to project the image from border to border. However, when the raster scanner reaches the blanking period 440, the projected laser light is suppressed and one of the laser signals R, G, B is tested. As shown by the testing signals 450, the red laser 125 is tested during the first blanking period 440 and the blue laser 120 and green laser 115 are off. During the next blanking period 440, the green laser 115 is tested and the red laser 125 and the blue laser 120 are off, and so on. The testing signal 450 is sensed by the photodiode 130 which send the signal to the controller 110.

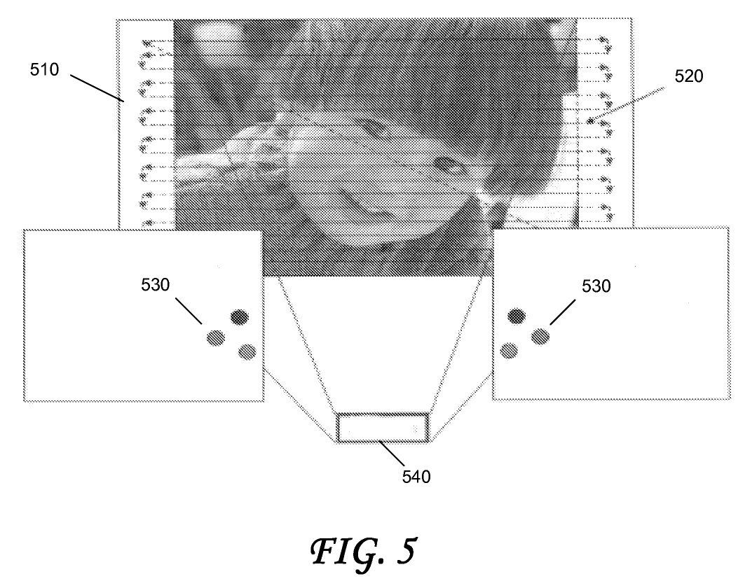

The process of suppressing laser light during the blanking period 440 may be performed using mechanical stops 530, as shown in FIG. 5. In this manner, the raster scanner 540 scans along the line 520 and would hit one of the mechanical stops 530. The mechanical stop 530 would cause the controller 110 to suppress the laser light.

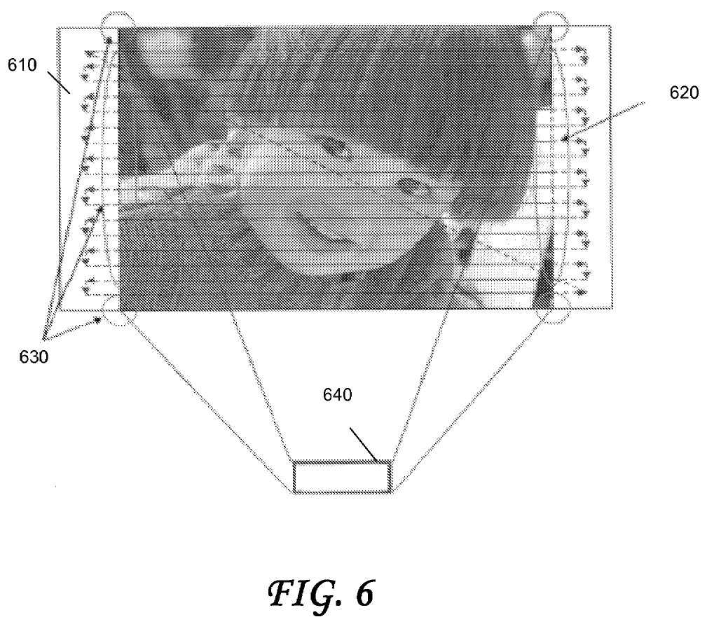

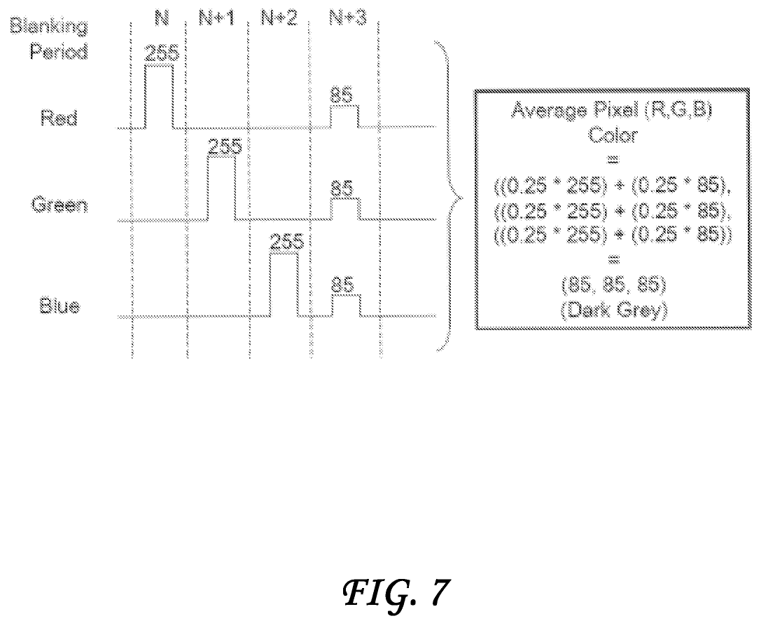

As shown in FIG. 6, the laser light may also be suppressed during the blanking period 440 using a special color pattern that averages the light to a nearly invisible dark grey. In this manner, the raster scanner 640 scans along the line 620 and would reach the blanking period edges 630. At this point, as shown FIG. 7, for successive blanking periods, the controller 110 will modify the color of the boarding pixels for photodiode 130 reads using a special color pattern that averages so that the pixel values for R, G, and B would be (85, 85, 85) which is dark grey.

Returning to FIG. 3, once the blanking period has ended and one of the lasers 115, 120, 125 has been tested, the process continues to step 3800 where the controller 110 advance the raster scanner's position. The process continues as discussed above.

As one of skill in the art may appreciate, the image projection system 100 discussed herein, may be integrated into an electronic device, such as a cellular (mobile) telephone, Personal Digital Assistant (PDA), MP3 player, or any similar wireless device.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the controller 110 in FIGS. 1 and 2 each processing the content in various possible ways. It does not necessarily need to be one system used by all end users. Accordingly, the appended claims and their legal equivalents should only define the invention, rather than any specific examples given.

We claim:

1. A method for monitoring laser power during a raster scan projection operation using a single photodiode, comprising:
determining a position of a raster scan device during projection of an image;
determining if the raster scan device position is in or near a blanking period, wherein if the raster scan position is in or near a blanking period,
blocking bright light from being projected; and
testing one of a red laser, a green laser, and a blue laser.

2. The method of claim 1, wherein bright light is blocked from being projected in or near the blanking periods using mechanical stops.

3. The method of claim 1, wherein bright light is blocked from being projected in or near the blanking periods using a color pattern that averages to a substantially invisible color.

4. The method of claim 1, further comprising:
synchronizing data from the red laser, the green laser, and the blue laser.

5. The method of claim 1, wherein the red laser, the green laser, and the blue laser are each tested in an alternating pattern such that only one laser is tested during each blanking period.

6. The method of claim 1, wherein the blanking period is located in at least one of the area to the left of the left border of the image and to the right of the right border of the image.

7. The method of claim 1, wherein if the raster scan position is not in a blanking period, image data are projected on the screen.

8. An apparatus that monitors laser power during a raster scan operation, comprising:
a single photodiode that senses laser light;
a raster scan device that scans an optical beam for image projection; and
a controller that determines the position of the raster scan device during projection of the image, wherein if the raster scan device position is in or near a blanking period, the controller blocks light from being projected and tests one of a red laser, a green laser, and a blue laser, and the single photodiode senses the light from the laser test and sends a sensing signal to the controller.

9. The apparatus of claim 8, further comprising:
mechanical stops that block bright light from being projected in the blanking periods.

10. The apparatus of claim 8, wherein the controller blocks bright light from being projected in or near the blanking periods using a color pattern that averages to a substantially invisible color.

11. The apparatus of claim 8, wherein the controller synchronizes data from the red laser, the green laser, and the blue laser.

12. The apparatus of claim 8, wherein the controller tests the red laser, the green laser, and the blue laser in an alternating pattern such that only one laser is tested during each blanking period.

13. The apparatus of claim 8, wherein the blanking period is located in at least one of the area to the left of the left border of the image and to the right of the right border of the image.

14. The apparatus of claim 8, wherein the apparatus is integrated into one of a cellular telephone, mobile telephone, Personal Digital Assistant (PDA), and MP3 player.

15. An electronic device that monitors laser power during a raster scan operation, comprising:
a single photodiode that senses laser light;
a raster scan device that scans an optical beam for image projection; and
a controller that determines the position of the raster scan device during projection of the image, wherein if the raster scan device position is in or near a blanking period, the controller blocks light from being projected and tests one of a red laser, a green laser, and a blue laser, and the single photodiode senses the light from the laser test and sends a sensing signal to the controller.

16. The electronic device of claim 15, further comprising:
mechanical stops that block bright light from being projected in the blanking periods.

17. The electronic device of claim 15, wherein the controller blocks bright light from being projected in or near the blanking periods using a color pattern that averages to a substantially invisible color.

18. The electronic device of claim 15, wherein the controller tests the red laser, the green laser, and the blue laser in an alternating pattern such that only one laser is tested during each blanking period.

19. The electronic device of claim 15, wherein the blanking period is located in at least one of the area to the left of the left border of the image and to the right of the right border of the image.

20. The electronic device of claim 15, wherein the electronic device one of a cellular telephone, mobile telephone, Personal Digital Assistant (PDA), and MP3 player.
